(19) United States
(12) Patent Application Publication
(10) Pub. No.: US 2025/0008948 A1
(43) Pub. Date: Jan. 9, 2025

(54) COATING FOR FLOWER HEADS

(71) Applicant: LIQUIDSEAL HOLDING B.V., Leiden (NL)

(72) Inventors: Victor Steven MONSTER, LEIDEN (NL); Eugene Robert VAN DEN BERG, LEIDEN (NL); Glenn Gareth GROENEWEGEN, LEIDEN (NL)

(21) Appl. No.: 18/892,137

(22) Filed: Sep. 20, 2024

Related U.S. Application Data
(62) Division of application No. 17/025,851, filed on Sep. 18, 2020, now abandoned.

(30) Foreign Application Priority Data
Sep. 18, 2019 (NL) 2023845

(51) Int. Cl. A01N 3/02

(52) U.S. Cl. CPC A01N 3/02

(57) ABSTRACT

Disclosed is a method for coating flower heads to prevent or slow down, infection of flower heads during storage and transport to final retail, using a coating composition containing a polyvinyl acetate homopolymer and water, and optionally comprising a spacing agent, the composition being in the form of a dispersion.

### CROSS REFERENCE TO RELATED APPLICATION

This application is a divisional application of U.S. patent application Ser. No. 17/025,851, filed Sep. 18, 2020, which claims benefit to Netherlands Application Serial No. NL 2023845, filed Sep. 18, 2019, the contents of which are incorporated herein by reference.

### BACKGROUND OF THE INVENTION

The invention relates to a composition for coating flower heads to prevent or slow down, infection of flower heads during storage and transport to final retail, and a use of the coating composition. The invention also relates to a flower coated with said composition. The invention is especially suitable for flower heads of roses and rose buds.

Roses are harvested in an early to late pre-opening stage, and subsequently cooled for transport by various means such as air transport but also by ship/container to countries and markets of end use. At arrival, roses are then transported to cooled storage facilities, but may be moved between cooled storage facilities a number of times during which condensation of ambient water vapor on the flowers will occur. Here they remain until marketing and retail shipping.

Facilitated by the wet surface of buds, a number of infections may occur or become manifest during and after storage, especially with molds and in particular botrytis species. These organisms and their spores presumably are present in low density or frequency in all roses already at harvest, but may and will spread through the stored plants. This again will seriously affect retail prices of such roses if not lead to outright losses. More importantly, such spores are present at relevant quantities in all circulating air and especially so in processing facilities where dust of dead flower and plant material is present at high concentrations.

An effective strategy has been developed for reducing the risk of Botrytis infections in cut roses has been disclosed in WO2012/125023 A1, which describes a composition for coating flower heads post-harvest to inhibit or prevent infection of the flowers during transport and storage, which composition comprises a copolymer produced from the monomers vinyl acetate and ethylene, and optionally a vinyl ester of a highly branched carboxylic acid, glycerol and water, the composition being in the form of a dispersion.

There is still a strong need in cut flower industry for a method and product for protection during post-harvest storage and transport of flowers, especially roses. Objects of the invention are therefore to provide a means for protection of flowers, especially roses, during storage and a storage method, that effectively controls a mini-environment surrounding each individual flower head, wherein these are further protected from harmful influences, in which the storage life of the flower head is extended and whereby the flower, once opened, remains appreciable to clients for a longer period of time (extended vase life). The inventors considered the application of a coating to flower heads, especially roses. Such a coating must allow for the continued, even if only minimal, dimensional and structural growth and maturation of the flower head and the flower petals contained within.

### SUMMARY OF THE INVENTION

The inventors have found that the objectives mentioned above can be achieved by a composition for coating flower heads, in particular early in the post-harvest phases comprising a polyvinyl acetate homopolymer, and water, the composition being in the form of a dispersion. Optionally the composition comprises a spacing agent.

The invention therefore relates in a first aspect to a composition for coating flower heads to inhibit or prevent infection of the flowers during transport and storage, which composition comprises a polyvinyl acetate polymer and water and optionally comprises a spacing agent, the composition being in the form of a dispersion.

In a second aspect the invention relates to a flower, which comprises a flower head coated with the composition according to the first aspect.

In a third aspect the invention relates to a method of inhibiting or preventing infection of cut flowers during transport and storage by applying to the flower heads a composition of the first aspect to form a coating.

The inventors have surprisingly found that an aqueous dispersion on the basis of a polyvinyl acetate homopolymer provides a means for protection of flowers, especially roses, during storage and a storage method, that effectively controls a mini-environment surrounding each individual flower head, wherein these are further protected from harmful influences, in which the storage life of the flower head is extended and whereby the flower, once opened, remains appreciable to clients for a longer period of time (extended vase life). The composition is very applicable to coat flower heads, especially roses. The coating produced with the composition of the invention allows for continued, even if only minimal, dimensional and structural growth and maturation of the flower head and the flower petals contained within.

The coating composition is applied to the flower heads of harvested flowers. After drying to the air a protective film is formed around the tissues (top of stem, bud remains and flower head with early opening flower petals). This protective film (coating) has a degree of plasticity that allows for maintained integrity of the coating membrane during the post-coating phase of shape changes of the flower head petals to auction and the period beyond. The coating formed has sufficient water permeability and permeability to oxygen and carbon dioxide. The present coating composition may act as a carrier for slow release of bioactive agents, such as crop protection agents (CPAs).

The invention herewith provides a powerful means to inhibit degradation or prevent damage, infection and losses of cut flowers during storage. Coating flowers with composition according to the invention leads to inhibition and/or prevention of Botrytis infection of the flowers.

### DETAILED DESCRIPTION OF THE INVENTION

The invention is based on the finding that a polyvinyl acetate in combination with a spacing agent in an aqueous dispersion can be used for coating a flower head, especially a rose flower head, after harvest, to inhibit metabolic degradation of the flower.

In addition, the use of polyvinyl acetate in combination with a spacing agent gives the coated flower a surprisingly shiny appearance, compared to other polymer based coatings. This may increase appeal of flowers.

Polyvinyl acetate (PVA, PVAc) in the context of the invention can be prepared by the polymerization of vinyl acetate monomer and is an aliphatic synthetic polymer with the formula (C₄H₆O₂)ₙ. The degree of polymerization of polyvinyl acetate is typically 100 to 5000. The ester groups of the homopolymer are sensitive to hydrolysis resulting in polyvinyl alcohol and acetic acid. This hydrolysis surprisingly has no significant detrimental effects on the shelf life of flowers coated with the composition of the invention.

The dispersion produced from these polymers allow for inclusion of a spacing agent, and do not sequester this at drying into a film. Further, these polymer dispersions accept the inclusion and effective release of bioactive agents.

The composition according to the invention may comprise the polyvinyl acetate homopolymer in an amount of from 1 to 25% by weight of the composition. Preferably the composition of the invention comprises the polymer in an amount of from 1 to 7.5% by weight of the composition, preferably between 2 and 6% by weight of the composition more preferably in an amount of from 2.5 to 5%.

The polyvinyl acetate allows inclusion of so called spacing agents. The presence of this spacing agent provides channels (spaces) for diffusion of metabolic gases, allowing a minimal continued metabolism and maturation of the flower head within the coating, so that in particular in case of coating flowers with the composition according to the invention the development and bloom is not adversely impacted.

It is therefore preferred that the composition comprises a spacing agent. The spacing agent may be present in an amount between 0.001 and 20.0% w/v based on the volume of the composition, such as between 0.01 and 10% w/v, such as approximately 0.1% w/v based on the volume of the composition. Particularly useful compositions may comprise spacing agent between 0.05 and 0.5%, such as 0.1% w/v based on the volume of the composition. With these concentrations a minimal continued metabolism and maturation of the flower head within the coating is ensured. These low concentrations of spacing agent also contribute to reduced stickiness of the coatings when applied on the freshly harvested flower.

It is preferred that said spacing agent is a polyol, such as a diol or a triol. Inclusion of polyols in the composition reduces stickiness of coatings compared to other spacing agents described in the art such as starch. Suitable polyols include glycols and polyethers. Suitable polyols may be selected from the group of glycerol, sorbitol, propylene glycol, polyethylene glycol (polyethylene oxide) or mixtures thereof.

Preferably said spacing agent is glycerol. In another preferred embodiment the spacing agent is polyethylene glycol (PEG). In another embodiment the spacing agent is propylene glycol. Glycerol, propylene glycol or PEG may be present in an amount between 0.001 and 20% w/v based on the volume of the composition, such as between 0.01 and 10% w/v. Suitable glycerol, propylene glycol or PEG amounts may be in the range of between 0.005 and 0.75%, between 0.005 and 0.5%, between 0.01 to 1.0%, between 0.01 and 0.75% or between 0.01 and 0.5% w/v based on the volume of the composition. Particularly useful compositions may comprise glycerol, propylene glycol or PEG in an amount of 0.1% w/v of glycerol, propylene glycol or PEG based on the volume of the composition. An advantage of having glycerol, propylene glycol or PEG in the composition in these concentrations is that the coating remains intact even a high relative humidity. These low concentrations of glycerol, propylene glycol or PEG also contribute to reduced stickiness of the coatings when applied on freshly harvested flowers.

For the same reasons preferred compositions according to the invention, comprise said spacing agent in an amount of from 0.01 to 20% by weight of the polymer within the composition, more preferably in an amount of from 0.01 to 10% by weight of the polymer within the composition, even more preferably between 0.1 and 5% by weight of the polymer within the composition, such as between 0.5 and 5%, or between 1 and 5%. These amounts relate suitably in particular to glycerol, propylene glycol and PEG.

The composition according to the invention may comprise the polymer (in an amount of from 1 to 25% by weight of the composition. Preferably the composition of the invention comprises the polymer in an amount of from 1 to 7.5% by weight of the composition, more preferably in an amount of from 2 to 6%, spacing agent in an amount of from 0.01 to 20% by weight of the polymer content, more preferably from 0.01 to 10% by weight of the polymer content, the balance of the composition being water.

The amount of polymer and the amount of spacing agent will determine the permeability and the capacity for encapsulation of water soluble bioactives of the coating formed from the dispersion. The person skilled in the art will appreciate that, by varying the relative amounts of polymer and spacing agent, the permeability to water and gasses may be controlled. If a coating less open to water and gas transmission is desired, the relative amount of polymer may be increased, whereas less spacing agent is required. In this respect, also the choice of the specific polymer plays a role. The person skilled in the art will appreciate that, by varying the type of polymer used for the base of the coating—provided the dry film will fully incorporate the spacing agent—films of variable properties with respect to tensile strength, flexibility and transparency will be formed to suit any application required for functional or for example health and safety or legal reasons, while retaining the capability of functioning as low-dose/slow-release system for any water soluble agent or formulation entrapped within the dry film formed. The spacing agent provides both space for initial storage and diffusion pathways for subsequent release by diffusion of entrapped water soluble bioactive agents, such as CPAs. The composition may therefore comprise one or more bioactive agents. The coating formed from the coating composition of the invention provides a barrier function to newly attaching spores from the ambient air, causing such spores, as well as those present at the moment of coating and trapped under the coating, to be exposed to CPAs enclosed in the film. These are enclosed at high concentrations, but very small quantities, within the coating film formed after drying. These bioactive agents may be selected from the group of ethylene oxidants or neutralizers, anti-microbiotics, fungicides, stabilizers, anti-parasitics, anti-infection means, other biologically active compounds, compounds controlling biological active molecules, useful bacteria, useful fungi, useful enzymes, UV-stabilizers, UV-blockers, etc. Such bioactive agents can be chosen from any available and suitable bioactive agents. Such bioactive agents will be used in order to further improve the condition during storage of the cut flowers and to further maintain health, appearance and thus commercial value in a later stage of commercial use. Preferably the bioactive agents do not form a health or environmental risk. Preferably the bioactive agents are used in a total amount of less than 5 wt. %, based on the total polymer mass forming the dispersion or coating composition. For practical purposes, the bioactive agents are preferably water soluble, though other bioactive agents, which can be made water-soluble, such as by using a carrier or encapsulation, are also applicable. In other cases an emulsifier may be added. Based on experiences gleaned from the experiments and studies described in the illustrations below, such bioactive agents are released in a protracted manner, improving bioavailability thereof. Preferred bioactive agents are selected from the group of ethylene oxidants or neutralizers, anti-biotics, fungicides, pesticides, fertilizers and anti-parasitics.

The coatings obtained by applying the coating compositions of the invention to flower heads and drying, comprising various other ingredients which are releasable, surprisingly offer a further advantage of slowly, and thereby more effectively, releasing these ingredients into a very small virtual space between said coating and the surface of any biological structure or tissue coated. All bioactive agents dissolved in the dispersion solvent, being water, are concentrated into the ensuing film. Due to the absence of any perceivable sequestration, they are distributed throughout the film as formed. With fixed concentrations in the dispersion, reducing polymer solid content giving diminishing thickness of the ensuing film, progressively higher concentrations of these bioactive agents in the polymer film are achieved. With reducing film thickness average diffusion time for any bioactive agents contained and distributed homogenously within the coating to the surface of any coated structure decreases. Thus dosage/time relationships as well as locally or topically achieved concentrations can be controlled. The use of these coatings thereby allows for a significant reduction in the overall amounts of ingredients required for effectively achieving any biological purpose.

Especially, in view of the decreased risk of fungal infection when applying the coating composition of the invention, the amount of fungicide to be added to the composition is in some cases only 5 to 20% of the amount required conventionally (by short dipping in or spraying of aqueous solutions containing fungicides).

Not only are such included ingredients more effective with respect to their intended purpose, but also a reduction of amounts required is achieved, reducing the costs involved therewith while simultaneously reducing any possible adverse effects on the environment associated with their use. Similarly residues remaining on any commercially sold flowers to which the public may become exposed may be significantly reduced, in some cases 30 fold reductions having been recorded.

Preferably, the composition of the invention is essentially free of any volatile solvents, especially free of alcohol solvents, since such solvents are toxic for roses and other plants.

Within the scope of the invention also concentrated polymer dispersion compositions are envisaged, that is with a low water content, such as less than 50 wt. %, preferably less than 25 wt. %. These concentrated polymer dispersion compositions may therefore be transported easier, and can be diluted prior to use to the desired concentrations.

As mentioned above the permeability to water should be sufficient to allow excess water (a product of metabolic breakdown of starches) to pass through the coating, once the coating is applied to a flower head. Such excess free water on the interfaces to the external environment (damp barrier) may be formed during sharp temperature changes. On the other hand, the coating once applied, should limit the amount of water loss of the flower buds.

Further, the coating should be suitably permeable to gasses, specifically to oxygen and carbon dioxide. If so, the enclosure effectively controls the levels of such gasses within its confines, thereby forming stable conditions in the mini-environment enclosing the flower buds. The conditions in the mini-environment are beneficial for this “crop” with e.g. respect to storage lifespan, i.e. “vase life”, and appreciation.

Typical physical values associated with the preferred permeability to gasses and water for such a coating are for instance, a water permeability of larger than 300 ml/m².bar.day, an oxygen permeability of less than 100 ml/m².bar.day, and a carbon dioxide permeability of less than 200 ml/m².bar.day, as measured at 25° C., with a coating membrane thickness of 25 μm, and a relative humidity of 0%.

Depending on the specific composition of the coating, the coating further may act as a UV-absorber and/or UV-reflector. As mentioned above, the coating supports the formation of a mini-environment. Such a mini-environment may protect the enclosed flower head from light, more specifically from UV-light. Light typically has a negative effect on the storage life and appearance of cut flowers. If the coating acts as a UV-absorber and/or a UV-reflector, thereby effectively limiting the exposure of the budding flowers to UV-light, storage life will be increased and the appearance of the cut flowers will remain acceptable for a longer time. To this end, additional UV-blockers and/or UV-stabilizers may be added to the composition.

Typical values for the viscosity of the dispersion compositions are from 5-20 mPas (as determined according to the Hoeppler falling ball method, with a 3 wt. % solution at 20° C.).

In a second aspect the invention relates to a flower, which comprises a flower head coated with the composition according to the first aspect.

This flower can be cut flower or an uncut flower, for instance of a potted plant. The composition according to the invention is in particular suitable for coating cut flowers post-harvest. Therefore the flower preferably is a cut flower.

The flower may be any flower. Non-limiting examples are alstroemeria, aster, banksia, begonias, bellflower, campanula, Strelitzia reginae, bulb flowers, freesia, tulip, lobelia, amaranthus, Nigella, oleander, orchids, busy lizzies, Dianthus caryophyllus, Chrysanthemum, Clematis, cyclamen, daisies, delphinium, gardenia, geraniums, gerberas, gladioli, Gypsophilia, Calluna vulgaris), hydrangeas, iris, Lilium, pansy, petunias, roses (Rosa), snapdragon, Helianthus, etc. Very good results are obtained with roses.

In addition to roses, particular advantageous effects were observed in this respect when the composition was applied on flowers selected from the group of sedum, bouvardia, gerbera, carnation, or hypericum (also with regard to its berries). In a third aspect the invention relates to a method of inhibiting or preventing infection of flowers during transport and storage by applying to the flower heads a composition as defined above to form a coating.

The method is in principle suitable for coating cut flowers or an uncut flowers, for instance of a potted plant. Preferably the method is for coating cut flowers post-harvest.

The coating creates a mini-environment around the flower head. As mentioned above, such a mini-environment effectively controls the water and gas levels inside.

The coating according to the invention preferably has a thickness after formation of 0.3 to 12 μm, more preferably of 1.5 to 3 μm, even more preferably of 0.75 to 1.5 μm. It is clear that if the coating is too thick, permeability towards water will be hampered too much, and if the coating is too thin, the enclosure will be too open to gasses, and further a risk of uneven coatings, which may show ruptures or holes, arises. In addition, with very thin coatings and higher concentrations of bioactive agents included, concentrations from rapidly released bioactive agents may, although quantities in absolute sense may be biologically or from a health and safety perspective negligible, become locally toxic to the exposed plant tissues especially in the case of vulnerable flower petals.

The coating composition (dispersion) according to the invention may be applied one or more times directly on the flower heads, thereby forming a coating. Preferably the dispersion is applied once, but may be applied without evident penalty twice. The coating dispersion can be applied by several techniques, preferably by spraying or immersion rather than by brushing. When the polymer dispersion used has a high viscosity, preferably dilution before using spraying is used for applying the dispersion, whereas with a polymer dispersion with a low viscosity, preferably a spraying/immersion technique is used. The coating is allowed or made to dry after being applied.

In view of environmental issues the coating is preferably water soluble. Thereby, e.g. bacteria more rapidly and easily break down the coating after its use into harmless products, i.e. carbon dioxide and water. In view of the extremely thin layer of dried film used, and the biodegradable nature of the plant tissues coated, breakdown for full digestion in composting is not evidently impaired.

The description above is included in order to illustrate the preferred embodiments of the present invention, and not to limit the scope of the invention. For the person skilled in the art many variations will be evident, in light of the description above that fall under the scope of the present invention.

Therefore, the following examples are meant to illustrate the invention, and not to limit the invention.

### EXAMPLES

The following illustrations of principles, methods and effects have made use of several coating dispersion variants, and have used different methods of application.

Cut white roses and red roses of approximately 60 cm were subjected to test the effects of applying a composition according to the invention onto their flower heads. For this purpose, flower heads were spray coated with various compositions according to the invention.

The polyvinyl acetate homopolymer was polyvinyl acetate homopolymer VINNEX 2510 BLOCKED obtained from Wacker.

When a CPA was used, this was the fungicide Switch, as distributed by Syngenta and was used in a concentration of 1 gram/liter.

### Example 1—White Roses/Propylene Glycol

Flower heads of white roses were spray coated with compositions containing 1%, 2.5%, 5% and 10% w/v polyvinyl acetate homopolymer+CPA. Compositions contained 0.01% or 0.1. % w/v propylene glycol as spacing agent. The roses were treated with specified formulas and subsequently, a bag was placed over the roses to induce elevated humidity. Rose were incubated at room temperature and after 2 days the bag was removed and the roses were assessed based on overall quality of the roses. As a control, uncoated roses were taken. Points are given for botrytis infection, sagging and other damages. The grading scale is from 0 (highest quality) tot 5 (worst quality) as indicated in table 1 below. Five roses were taken for each test condition and the average score from these five roses was determined.

TABLE 1
the effect of coating with a composition
according to the invention with varying
concentrations of polymer and propylene glycol.

| | White roses | | | | | | | | |
|---|---|---|---|---|---|---|---|---|---|
| | | Propylene glycol | | | | Propylene glycol | | | |
| | Contro1 | 0.01% w/v + CPA | | | | 0.1% w/v + CPA | | | |
| PVAc % W/V | 0 | 1 | 2.5 | 5 | 10 | 1 | 2.5 | 5 | 10 |
| Rose 1 | 2 | 1 | 0 | 0 | 2 | 1 | 0 | 1 | 1 |
| Rose 2 | 4 | 0 | 1 | 0 | 1 | 0 | 0 | 0 | 1 |
| Rose 3 | 1 | 1 | 1 | 1 | 2 | 0 | 1 | 0 | 0 |
| Rose 4 | 4 | 2 | 1 | 1.5 | 1 | 1 | 0 | 0 | 2 |
| Rose 5 | 3 | 1 | 0 | 1 | 3 | 1 | 0 | 1 | 1 |
| Average score | 2.80 | 1.00 | 0.6 | 0.7 | 1.8 | 0.6 | 0.2 | 0.4 | 1.0 |

The results in Table 1 show that roses coated with compositions according to the invention show lower average scores than uncoated roses, i.e. coated roses are of higher quality than uncoated roses.

### Example 2—Red Roses-Glycerol

Flower heads of red roses were spray coated with compositions containing 1%, 2.5%, 5% and 10% w/v polyvinyl acetate homopolymer+CPA as indicated in Table 2 below. One series of compositions contained polymer and no spacing agent. Other compositions contained 0.01% or 0.1% w/v glycerol as spacing agent. As controls an aqueous solution of CPA and uncoated roses were used. The roses were treated with specified formulas and subsequently a bag was placed over the roses to induce elevated humidity. Rose were incubated at room temperature and after 2 days the bag was removed and the roses were assessed based on overall quality of the roses. Points are given for botrytis infection, sagging and other damages. The grading scale is from 0 (highest quality) tot 5 (worst quality) as indicated in table 2 (parts 1 and 2) below. Eight roses were taken for each test condition and the average score from these eight roses was determined.

TABLE 2
(parts 1 and 2): the effect of coating
with a composition according to the invention
with varying concentrations of polymer and glycerol.
Part 1

| | Control | CPA | 0% W/V spacing agent + CPA | | | |
|---|---|---|---|---|---|---|
| PVAc % W/V | 0 | 0 | 1 | 2.5 | 5 | 10 |
| Rose 1 | 5 | 4 | 1 | 2 | 1 | 3 |
| Rose 2 | 4 | 3 | 2 | 1 | 3 | 1 |
| Rose 3 | 4 | 3 | 3 | 2 | 3 | 2 |
| Rose 4 | 3 | 2 | 2 | 3 | 3 | 3 |
| Rose 5 | 2 | 2 | 1 | 3 | 2 | 3 |
| Rose 6 | 5 | 4 | 1 | 1 | 2 | 1 |
| Rose 7 | 4 | 2 | 1 | 2 | 1 | 2 |
| Rose 8 | 3 | 1 | 2 | 2 | 2 | 3 |
| Average score | 3.8 | 2.6 | 1.6 | 2.0 | 2.1 | 2.3 |

Part 2

| | 0.01% W/V Glycerol + CPA | | | | 0.1% W/V glycerol + CPA | | | |
|---|---|---|---|---|---|---|---|---|
| PVAc % W/V | 1 | 2.5 | 5 | 10 | 1 | 2.5 | 5 | 10 |
| Rose 1 | 1 | 2 | 0 | 1 | 2 | 0 | 0 | 1.5 |
| Rose 2 | 2 | 0 | 1 | 2 | 3 | 0 | 0 | 2 |
| Rose 3 | 1 | 1 | 0 | 2.5 | 3 | 0 | 0.5 | 1 |
| Rose 4 | 2 | 1 | 2.5 | 2 | 2 | 1 | 0 | 1.5 |
| Rose 5 | 2 | 0 | 0 | 2 | 1 | 0 | 0 | 2 |
| Rose 6 | 2 | 1 | 1 | 2 | 2 | 1 | 2 | 1 |
| Rose 7 | 1 | 0 | 2 | 1.5 | 1 | 0 | 0 | 2 |
| Rose 8 | 2 | 1 | 1 | 2 | 2 | 0 | 1 | 2 |
| Average score | 1.6 | 0.8 | 0.9 | 1.9 | 2.0 | 0.3 | 0.4 | 1.6 |

The results in Table 2 show that roses coated with compositions according to the invention show lower average scores than uncoated roses. i.e. coated roses are of higher quality than uncoated roses. They also perform better than roses treated with CPA alone. Further, roses coated with compositions containing a spacing agent (glycerol) performed better than roses coated with compositions without a spacing agent.

1. A method for inhibiting or preventing infection of flowers during transport and storage, comprising coating the flowers with a composition containing a polyvinyl acetate homopolymer, a spacing agent and water, the composition being in the form of a dispersion.

2. The method according to claim 1, wherein applying said composition to the flower heads comprises post-harvest applying to flower heads of cut flowers.

3. The method according to claim 1, wherein the flowers are roses.

4. The method according to claim 1, wherein the composition is applied to the flower heads by spraying or immersion.

5. The method according to claim 1, wherein the composition is applied to form a thickness coating of from 0.3 to 12 μm, preferably from 1.5 to 3 μum, even more preferably 0.75 to 1.5 μm.

6. The method according to claim 1, wherein the infection comprises Botrytis infection of the flowers.

7. The method according to claim 1, wherein said composition comprises said polyvinyl acetate homopolymer in an amount of from 1 to 25% by weight of the composition.

8. The method according to claim 1, wherein said composition comprises said polyvinyl acetate homopolymer in an amount of from 1 to 7.5% by weight of the composition.

9. The method according to claim 1, wherein said composition comprises said polyvinyl acetate homopolymer in an amount of from 2 to 6% by weight of the composition.

10. The method according to claim 1, wherein said composition comprises said polyvinyl acetate homopolymer in an amount of from 2.5 to 5% by weight of the composition.

11. The method according to claim 1, wherein said composition comprises said spacing agent in an amount of from 0.01 to 20% by weight of the polymer within the composition.

12. The method according to claim 1, wherein said composition comprises said spacing agent in an amount of from 0.1 to 5% by weight of the polymer within the composition.

13. The method according to claim 1, wherein said spacing agent is a polyol.

14. The method according to claim 13, wherein said polyol is selected from the group of glycerol, sorbitol, propylene glycol, polyethylene glycol or mixtures thereof, preferably glycerol.

15. The method according to claim 14, wherein said polyol is glycerol.

16. The method according to claim 14, wherein said polyol is polyethylene glycol.

17. The method according to claim 14, wherein said polyol is propylene glycol.

18. The method according to claim 1, wherein said composition further comprises one or more bioactive agents selected from the group consisting of ethylene oxidants or neutralizers, anti-biotics, fungicides, pesticides, fertilizers and anti-parasitics.

19. The method according to claim 18, wherein said composition comprises said one or more bioactive agents in an amount of less than 5% by weight of the polymer within the composition.
